(19) United States
(12) Patent Application Publication
(10) Pub. No.: US 2013/0258052 A1
(43) Pub. Date: Oct. 3, 2013

(54) INTER-VIEW RESIDUAL PREDICTION IN 3D VIDEO CODING

(71) Applicant: QUALCOMM INCORPORATED, San Diego, CA (US)

(72) Inventors: Xiang LI, San Diego, CA (US); Ying CHEN, San Diego, CA (US); Marta KARCZEWICZ, San Diego, CA (US)

(73) Assignee: QUALCOMM Incorporated, San Diego, CA (US)

(21) Appl. No.: 13/771,897

(22) Filed: Feb. 20, 2013

Related U.S. Application Data
(60) Provisional application No. 61/616,936, filed on Mar. 28, 2012.

(51) Int. Cl. H04N 13/00

(52) U.S. Cl. CPC H04N 13/0048
USPC 348/43

(57) ABSTRACT

In general, this disclosure describes techniques for improved inter-view residual prediction (IVRP) in three-dimensional video coding. These techniques include determining IVRP availability based on coded block flags and coding modes of residual reference blocks, disallowing IVRP coding when a block is inter-view predicted, using picture order count (POC) values to determine whether IVRP is permitted, applying IVRP to prediction units (PUs) rather than coding units (CUs), inferring values of IVRP flags when a block is skip or merge mode coded, using an IVRP flag of a neighboring block to determine context for coding an IVRP flag of a current block, and avoiding resetting of samples of a residual reference block to zeros during generation.

This application claims the benefit of U.S. Provisional Application No. 61/616,936, filed Mar. 28, 2012, the entire contents of which are hereby incorporated by reference.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. Extensions include, for example, Scalable Video Coding (SVC) and Multi-view Video Coding (MVC) extensions of H.264/AVC. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes various techniques for improving performance of inter-view residual prediction (IVRP) in three-dimensional (3D) video coding, i.e., video data that, when rendered, can produce a 3D effect for a viewer. These techniques include determining an IVRP flag based on coded block flags and coding modes of residual reference blocks, disabling IVRP coding when a block is inter-view predicted, using picture order count (POC) values to determine whether IVRP is enabled, applying IVRP to prediction units (PUs) rather than CUs, inferring values of IVRP flags when a block is skip or merge mode coded, using an IVRP flag of a neighboring block to determine context for coding an IVRP flag of a current block, and avoiding resetting of samples of a residual reference block to zeros during generation. Any combination of these techniques may be applied by video coding devices, such as video encoders and video decoders.

In one example, a method of coding video data includes determining a disparity vector for a current block of video data in a current view based on depth information for the current block. The disparity vector indicates a location of a residual reference block of video data in a reference view relative to the current block. The method also includes determining a value of a coded block flag for the residual reference block, and coding the current block using inter-view residual prediction only when the value of the coded block flag indicates that the residual reference block includes at least one non-zero coefficient.

In another example, a video coding device includes a video coder configured to determine a disparity vector for a current block of video data in a current view based on depth information for the current block. The disparity vector indicates a location of a residual reference block of video data in a reference view relative to the current block. The video coder is also configured to determine a value of a coded block flag for the residual reference block, and code the current block using inter-view residual prediction only when the value of the coded block flag indicates that the residual reference block includes at least one non-zero coefficient.

In another example, a video coding device includes means for determining a disparity vector for a current block of video data in a current view based on depth information for the current block. The disparity vector indicates a location of a residual reference block of video data in a reference view relative to the current block. The video coding device also includes means for determining a value of a coded block flag for the residual reference block, and means for coding the current block using inter-view residual prediction only when the value of the coded block flag indicates that the residual reference block includes at least one non-zero coefficient.

In another example, a computer-readable storage medium has stored thereon instructions that when executed cause one or more processors to determine a disparity vector for a current block of video data in a current view based on depth information for the current block. The disparity vector indicates a location of a residual reference block of video data in a reference view relative to the current block. The instructions stored on the computer-readable medium, when executed, also cause the one or more processors to determine a value of a coded block flag for the residual reference block, and code the current block using inter-view residual prediction only when the value of the coded block flag indicates that the residual reference block includes at least one non-zero coefficient.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques for performing inter-view residual prediction.

FIG. 2 is a block diagram illustrating an example of a video encoder that may implement techniques for performing inter-view residual prediction.

FIG. 3 is a block diagram illustrating an example of a video decoder that may implement techniques for performing inter-view residual prediction.

FIG. 4 is a conceptual diagram illustrating an example MVC prediction pattern.

FIG. 5 is a flowchart illustrating an example method for encoding a current block of video data.

FIG. 6 is a flowchart illustrating an example method for decoding a current block of video data.

FIG. 7 is a flowchart illustrating an example method of coding video data using inter-view residual prediction.

FIG. 8 is a conceptual diagram illustrating an example of inter-view residual prediction.

FIG. 9 a conceptual diagram illustrating another example of inter-view residual prediction.

### DETAILED DESCRIPTION

This disclosure describes techniques related to coding multiview video data. Video data can correspond to a sequence of individual pictures played back at a relatively high frame rate. Video coders, such as video encoders and video decoders, typically utilize block-based video coding techniques in the course of converting source video data for transmission/storage and reconstructing such data for display. That is, video coders may divide each of the pictures into a set of individual blocks of video data, then code each individual block of the pictures.

Block-based video coding typically involves two general steps. The first step includes predicting a current block of video data. This prediction may be through the use of intra-prediction (that is, spatial prediction based on neighboring, previously coded blocks of the same picture) or inter-prediction (that is, temporal prediction based on one or more previously coded pictures). Performance of this prediction process generates a predictive block for the current block. The other step involves coding of a residual block. In general, the residual block represents pixel-by-pixel differences between the original, uncoded version of the current block and the predictive block. A video encoder forms the residual block by calculating the pixel-by-pixel differences, whereas a video decoder adds the residual block to the predictive block to reproduce the original block.

Multiview video data is generally used to produce a three-dimensional (3D) effect for a viewer. Pictures from two views (that is, camera perspectives from slightly different horizontal positions) may be displayed substantially simultaneously, such that one picture is seen by the viewer's left eye, and the other picture is seen by the viewer's right eye. Disparity between objects shown in the two pictures produces the 3D effect for the viewer.

Because the two pictures include similar information, multiview video coding techniques include inter-view prediction. That is, pictures of one view (a “base view”) may be intra- and inter-predicted (that is, temporally inter-predicted), and pictures of a non-base view may be inter-view predicted relative to pictures of the base view. In inter-view prediction, disparity motion vectors may be used to indicate locations of reference blocks for a current block in a current view, relative to a reference picture in a base view (or other reference view). Non-base views used as reference views may be considered base views when coding a non-base view relative to the reference view.

One additional technique that has arisen for multiview video coding is inter-view residual prediction (IVRP). This technique forms part of the current high efficiency video coding (HEVC) 3D video coding extension. In IVRP, there are essentially two predictions: generating a predicted block of a current block, e.g., using inter-prediction techniques, as well as a prediction of the residual value of the current block in the current view from a residual reference block in a reference view. Thus, a device such as a decoder device may determine a current block using IVRP as equal to the pixel values of the reference block of the current block plus the residual values corresponding to the reference block plus residual values predicted based on the residual values corresponding to the reference block.

In one example, a current block (e.g., a prediction unit (PU)) is denoted CB, the predicted block for CB is denoted PB, and the residual reference block for the current block is denoted RRB. The residual for CB, which is denoted as CB_{R}, can be expressed as follows:

CB_{R}=CB−PB−RRB.

In this manner, only CB_{R} is transformed. That is, it should be understood that PB and RRB can be expressed in the pixel domain.

Thus, in the foregoing example, to reconstruct CB, a video decoder may calculate the following, using the denotations above:

CB=PB+(RRB+CB_{R}).

More particularly, the video decoder may receive quantized transform coefficients for CB_{R}, which the video decoder may inverse quantize and inverse transform to reconstruct CB_{R}. The video decoder may then determine PB using prediction information (e.g., motion information) for CB, and determine RRB using depth information associated with CB, e.g., to determine a disparity vector that points to a block including RRB. The video decoder may then add the determined values of PB and RRB to the decoded values for CB_{R}.

Currently, HEVC 3DV proposes determining whether IVRP is available based on an analysis of each of the pixels in the residual reference block (hereinafter “RRB”) to determine whether any of the pixels is non-zero. Thus, both a video encoder and video decoder would need to individually analyze each value of the RRB, and determine that IVRP is available only when at least one of the values in the RRB is non-zero. Moreover, it is important to note that to determine the availability of and analyze the data corresponding to the RRB, the block has to be generated first. The generation process includes inverse quantization, inverse transform, and potentially interpolation. Moreover, when a part of the RRB is covered by an intra-coded or inter-view predicted block, the samples of that part are reset to zero. Thus, the process of determining whether IVRP is available is relatively processor intensive.

This disclosure, however, describes techniques for simplifying the determination of IVRP availability in video coding operations and coding operations related thereto. For example, rather than performing the detailed analysis described above, the techniques of this disclosure include analyzing coded block flags (CBFs) for each block of the reference picture that overlaps the reference block. CBFs generally indicate whether a block includes non-zero coefficients. Thus, a video coder may execute a relatively simple operation, e.g., perform a bitwise OR across the CBFs of all blocks touched by the reference block, to determine whether IVRP is available for a current block. It is noted that a reference block in a reference picture does not necessarily align perfectly with one of the coded blocks of the reference picture, but may occur at any arbitrary point in the reference picture. Thus, the device may need to analyze more than one CBF corresponding to each of multiple coded blocks of the reference picture that overlap with the reference block. In the foregoing manner, the video coder may perform a relatively simpler check of the CBFs of blocks in the reference picture that overlap the reference block, which may reduce coder complexity, as well as reduce processor and memory requirements for the coder.

In addition, the determination of whether IVRP is available can be further simplified by first determining whether the picture order count (POC) value of the temporal reference picture of the current block is the same as the POC value of the temporal reference picture of the residual reference block. The POC values of these pictures will only be the same when performing IVRP. Thus, if these POC values are different, the video coder need not check whether IVRP is available, because if these POC values are different, this indicates that IVRP is not being used. Additional features related to IVRP availability checking to which examples according to this disclosure are directed include applying IVRP to prediction units (PUs) rather than CUs, inferring values of IVRP flags when a block is skip or merge mode coded, using an IVRP flag of a neighboring block to determine context for context-adaptive binary arithmetic coding (CABAC) coding an IVRP flag of a current block, and avoiding resetting of samples of a residual reference block to zeros during generation.

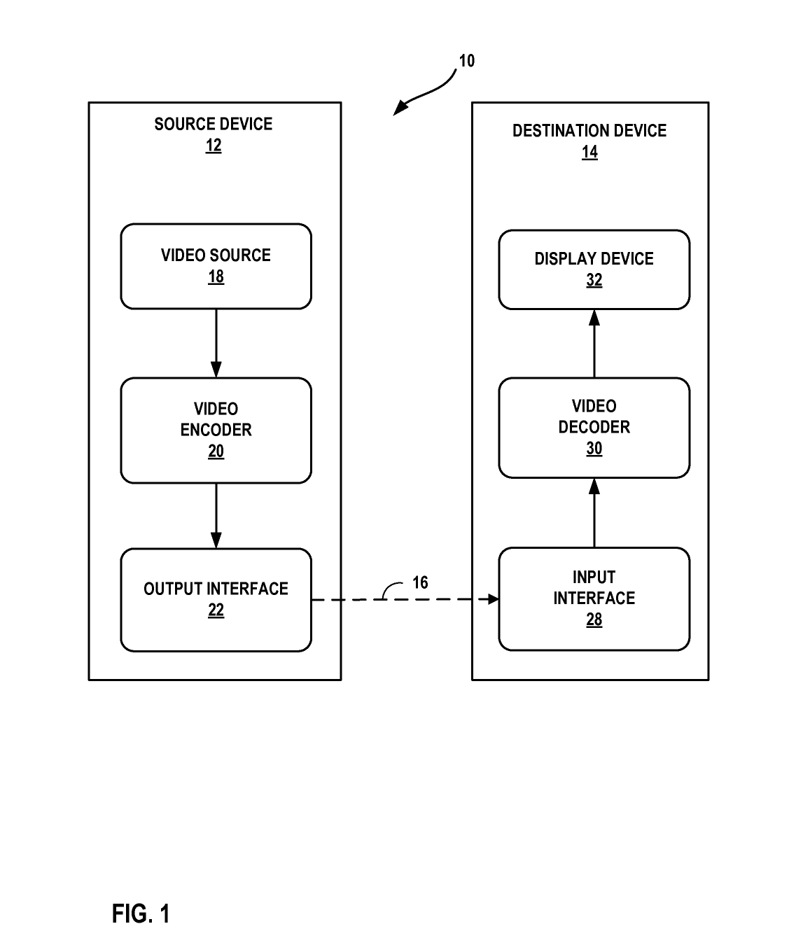

FIG. 1 is a block diagram illustrating an example video encoding and decoding system 10 that may be configured to employ inter-view residual prediction in accordance with this disclosure. As shown in FIG. 1, system 10 includes a source device 12 connected to a destination device 14 via a computer-readable medium 16. Source device 12 and destination device 14 can be any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 are equipped for wireless communication.

In the example of FIG. 1, source device 12 includes video source 18, video encoder 20, and output interface 22. Destination device 14 includes input interface 28, video decoder 30, and display device 32. In other examples, a source device and a destination device may include other components or arrangements. For example, source device 12 may receive video data from an external video source 18, such as an external camera. Likewise, destination device 14 may interface with an external display device, rather than including an integrated display device. In any event, source device 12 provides encoded video data via computer readable medium 16 to be decoded at a later time by destination device 14. For example, video source 18 provides video data to encoder 20, which encodes the video source data and passes the coded video to output interface 22. The coded video data can be transmitted/stored by output interface 22 of source device 12 via computer-readable medium 16. Input interface 28 of destination device 14 may receive or retrieve the coded video data from computer-readable medium 16. Input interface 28 can communicate the coded video data to decoder 30, which decodes the coded video data and communicates the decoded video to display device 32 for display.

In the course of coding, storing, and transmitting video data, source device 12 and/or destination device 14 may employ a number of different video coding techniques, including intra and inter-prediction, as well as inter-view prediction techniques. Additionally, in accordance with this disclosure, source device 12 and/or destination device 14 may be configured to efficiently determine the availability of and execute coding operations in accordance with IVRP. For example, video encoder 20 of source device 12 may be configured to perform IVRP in accordance with this disclosure on video data received from video source 18, while video decoder 30 of destination device 14 may be configured to perform IVRP on video data received via input interface 28.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications.

Captured, pre-captured, or computer-generated video may be encoded by video encoder 20. In some examples, video encoder 20 employs block based video coding techniques to encode video data received from video source 18. To encode such video blocks, video encoder 20 can perform intra and/or inter-prediction to generate one or more prediction blocks. Video encoder 20 subtracts the prediction blocks from the original video blocks to be encoded to generate residual blocks. Thus, the residual blocks can represent pixel-by-pixel differences between the blocks being coded and the prediction blocks. Video encoder 20 can perform a transform on the residual blocks to generate blocks of transform coefficients. Following intra- and/or inter-based predictive coding and transformation techniques, video encoder 20 can quantize the transform coefficients. Following quantization, entropy coding can be performed by encoder 22 according to an entropy coding methodology.

A coded video block generated by video encoder 20 can be represented by prediction information that can be used to create or identify a predictive block, and a residual block of data that can be applied to the predictive block to recreate the original block. The prediction information can include motion vectors used to identify the predictive block of data. Using the motion vectors, video decoder 30 may be able to reconstruct the predictive blocks that were used by video encoder 20 to code the residual blocks. Thus, given a set of residual blocks and a set of motion vectors (and possibly some additional syntax), video decoder 30 can reconstruct a video frame or other block of data that was originally encoded. Inter-coding based on motion estimation and motion compensation can achieve relatively high amounts of compression without excessive data loss, because successive video frames or other types of coded units are often similar. An encoded video sequence may include blocks of residual data, motion vectors (when inter-prediction encoded), indications of intra-prediction modes for intra-prediction, indications of inter-view prediction modes for inter-view prediction, and syntax elements.

Video encoder 20 may also utilize intra-prediction techniques to encode video blocks relative to neighboring video blocks of a common frame or slice or other sub-portion of a frame. In this manner, video encoder 20 spatially predicts the blocks. Video encoder 20 may be configured with a variety of intra-prediction modes, which generally correspond to various spatial prediction directions.

The foregoing inter and intra-prediction techniques can be applied to various parts of a sequence of video data including frames representing video, e.g., pictures and other data for a particular time instance in the sequence and portions of each frame, e.g., slices of a picture. In the context of multiview video coding (MVC), including MVC plus depth and other 3DVC processes using depth information, such a sequence of video data may represent one of multiple views included in a multi-view coded video. Various inter and intra-view prediction techniques can also be applied in MVC or MVC plus depth to predict pictures or other portions of a view. Inter and intra-view prediction can include both temporal (with or without motion compensation) and spatial prediction.

In examples according to this disclosure, video encoder 20 of source device 12 is configured to execute operations related to one form of inter-view prediction known as inter-view residual prediction, or, “IVRP.” As described above, in IVRP, there are essentially two predictions: a prediction of the block being coded from a reference block, as well as a prediction of the residual value from the residual of the reference block. In one example, decoder 30 of destination device 14 determines a current block using IVRP as equal to the pixel values of a reference block of the current block plus the residual values corresponding to the reference block plus residual values predicted based on the residual values corresponding to the reference block.

In one example, a current block (e.g., a prediction unit (PU)) is denoted CB, the predicted block for CB is denoted PB, and the residual reference block for the current block is denoted RRB. The residual for CB, which is denoted as CB_{R}, can be expressed as follows:

CB_{R}=CB−PB−RRB.

In this manner, only CB_{R} is transformed. That is, it should be understood that PB and RRB can be expressed in the pixel domain.

Thus, in the foregoing example, to reconstruct CB, video decoder 30 of destination device 14 can calculate the following, using the denotations above:

CB=PB+(RRB+CB_{R}).

More particularly, video decoder 30 may receive quantized transform coefficients for CB_{R}, which video decoder 30 may inverse quantize and inverse transform to reconstruct CB_{R}. Video decoder 30 may then determine PB using prediction information (e.g., motion information) for CB, and determine RRB using depth information associated with CB, e.g., to determine a disparity vector that points to a block including RRB. Video decoder 30 may then add the determined values of PB and RRB to the decoded values for CB_{R}.

Currently, HEVC 3DV proposes determining whether IVRP is available based on an analysis of each of the pixels in the residual reference block to determine whether any of the pixels is non-zero. Thus, both video encoder 20 and video decoder 30 would need to individually analyze each value of the residual reference block, and determine that IVRP is available only when at least one of the values in the residual reference block is non-zero. Moreover, it is important to note that to determine the availability of and analyze the data corresponding to the residual reference block, the reference block has to be generated first. The generation process includes video decoder 30 executing inverse quantization, inverse transform, and potentially interpolation operations. Moreover, in the current version of HEVC 3DV, when a part of the residual reference block is covered by an intra-coded or inter-view predicted block, the samples of that part are reset to zero. Thus, the process of determining whether IVRP is available is relatively resource intensive.

This disclosure, however, describes techniques for simplifying the determination of IVRP availability in video coding operations. For example, rather than performing the detailed analysis described above, video encoder 20 can be configured to analyze coded block flags (CBFs) for each block of a reference picture that overlaps a reference block. CBFs generally indicate whether a block includes non-zero coefficients. Thus, video encoder 20 can execute a relatively simple operation, e.g., perform a bitwise OR across the CBFs of all blocks touched by the reference block, to determine whether IVRP is available for a current block.

In one example, video encoder 20 of source device 12 is configured to determine a disparity vector for a current block of video data in a current view based on depth information for the current block. Video encoder 20 also determines a value of a CBF for a residual reference block of video data in a reference view. The disparity vector determined by video encoder 20 identifies the residual reference block relative to the current block. Video encoder 20 can be configured to code the current block using IVRP only when the value of the CBF indicates that the residual reference block includes at least one non-zero coefficient.

In the event that video encoder 20 determines that the CBF of the residual reference block indicates that the residual reference block includes at least one non-zero coefficient, inter-view residual prediction may be (but is not necessarily) applied. In other words, when video encoder 20 determines that the CBF indicates that the residual reference block includes at least one non-zero coefficient, IVRP is available, and an IVRP flag may be coded indicating whether IVRP is applied to the current block coded by video encoder 20. On the other hand, when video encoder 20 determines that the CBF indicates that the residual reference block includes at least one non-zero coefficient, an IVRP flag need not be coded, as it may be determined that IVRP is not available.

In addition to the foregoing IVRP availability checking and coding techniques, video encoder 20 may be configured to employ any or all of a number of related techniques to improve efficiency, alone or in any combination. Generally speaking, IVRP and inter-view prediction are highly overlapped. As such, when a current block is inter-view predicted it may be inferred that it is advisable to disable IVRP for the current block. In one example, video encoder 20 can mark a residual reference block of an inter-view predicted block as unavailable when checking IVRP availability.

In some examples, the determination of whether IVRP is available can be further simplified by video encoder 20 first determining whether the POC value of the coded reference picture is the same as the POC value of the current picture being coded by encoder 20. The POC values of these pictures will only be the same when performing IVRP. Thus, if these POC values are different, the video coder need not check whether IVRP is available, because if these POC values are different, this indicates that IVRP is not being used.

As described in more detail below, a coded block of video data can be a number of different sizes. In some cases, a coded block of video data is referred to as a coding unit (CU). Each CU includes a number of sub-blocks of coded data referred to as prediction units (PUs). Different PUs in one CU can have quite different depth information. As such, video encoder 20 can, in some examples, be configured to apply IVRP at PU versus the CU level. For example, video encoder 20 can check IVRP availability and signal an IVRP flag at the PU level, rather than the CU level. Additionally, video encoder 20 can be configured to determine disparity vectors and locate residual reference data in a reference view based thereon at the PU versus CU level.

In one example, video encoder 20 is configured to infer a value for the IVRP flag of a current block being skip or merge mode coded. For skip and merge modes, motion information is inferred from predefined candidates. Similarly, video encoder 20 can be configured to infer the value of IVRP flag in the same way as that for the motion information in skip and merge mode. For example, if the reference block, from which video encoder 20 predicts motion information in skip or merge mode, has a particular value for its IVRP flag, then video encoder 20 can infer that the IVRP flag of the current block (being skip or merge mode coded) should have the same value. It should be understood that the reference block for the purposes of skip or merge mode corresponds to a selected block from a set of candidate blocks, such as spatially neighboring blocks to the current block, and is not the same as the reference block from which the current block is predicted or the residual reference block from which the residual is predicted.

Video encoder 20 can also be configured to improve CABAC coding of the IVRP flag by using the value of the IVRP flag of a neighboring block as the context to CABAC code the IVRP flag of the current block. For example, when the residual reference block of a neighboring block of the current block is available and the IVRP flag of the neighboring block is true, video encoder 20 can set the context index for coding the current IVRP flag to 1. Otherwise, video encoder 20 can set the context index to 0.

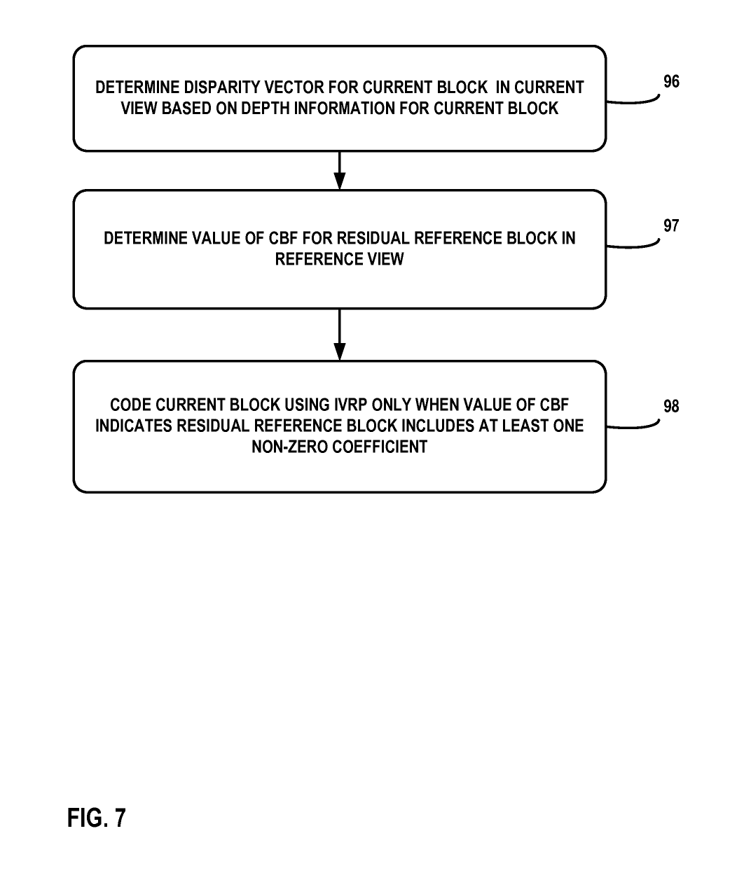

Some current video coding devices are configured to reset samples (e.g., pixels) of a residual reference block to zero if the reference block is covered by inter-view predicted blocks. However, it has been discovered that this sample resetting process may have little impact on general coding efficiency. Moreover, since inter-view prediction checking is also executed by video encoder 20 in the foregoing IVRP availability checking, it is not necessary to check it again. As such, in one example according to this disclosure, video encoder 20 is configured to avoid the whole residual reference block resetting process to simplify residual reference block generation. Additional details of the foregoing IVRP availability checking and coding processes is described in more detail below with reference to FIGS. 7-9.

Although reference is made to video encoder 20 employing IVRP techniques in accordance with this disclosure, in other examples, video decoder 30 or another device or component can be configured to employ such techniques. In general, video encoder 20 and/or video decoder 30 may be configured to perform any or all of the techniques of this disclosure for IVRP, in any combination. In this manner, video encoder 20, video decoder 30, and/or another device or component represent examples of a video coder configured to determine a disparity vector for a current block of video data in a current view based on depth information for the current block, determine a value of a coded block flag for a residual reference block of video data in a reference view, and code the current block using IVRP only when the value of the coded block flag indicates that the residual reference block includes at least one non-zero coefficient. The disparity vector identifies the residual reference block relative to the current block.

In addition to the foregoing intra and inter-prediction and inter-view prediction techniques, video encoder 20 can apply transform, quantization, and entropy coding processes to further reduce the bit rate associated with communication of residual blocks resulting from encoding source video data provided by video source 20. Transform techniques can in include, e.g., discrete cosine transforms (DCTs) or conceptually similar processes. Alternatively, wavelet transforms, integer transforms, or other types of transforms may be used. Video encoder 20 can also quantize the transform coefficients, which generally involves a process to possibly reduce the amount of data, e.g., bits used to represent the coefficients. Entropy coding can include processes that collectively compress data for output to a bitstream. The compressed data can include, e.g., a sequence of coding modes, motion information, coded block patterns, and quantized transform coefficients. Examples of entropy coding include context adaptive variable length coding (CAVLC) and CABAC.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful for communications between source device 12 and destination device 14.

In some examples, encoded data may be output from output interface 22 of source device 12 to a storage device, e.g. a computer-readable storage medium. Similarly, encoded data may be accessed from the storage device by input interface 28 of destination device 14. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

Video decoder 30 of destination device 14 receives encoded video data from source device 12 via computer-readable medium 16. For example, input interface 28 of destination device 14 receives information computer-readable medium 16 and video decoder 30 receives video data received at input interface 28. The information received from computer-readable medium 16 may include syntax information defined by video encoder 20, which is also used by video decoder 30, that includes syntax elements that describe characteristics and/or processing of coded video blocks and other coded units, e.g., a group of pictures (GOP). In some examples, destination device 14 includes a modem that demodulates the information. Output interface 22 and input interface 28 can include circuits designed for receiving data, including amplifiers, filters, and one or more antennas. In some instances, output interface 22 and/or input interface 28 may be incorporated within a single transceiver component that includes both receive and transmit circuitry. A modem may include various mixers, filters, amplifiers or other components designed for signal demodulation. In some instances, a modem may include components for performing both modulation and demodulation.

In one example, video decoder 30 entropy decodes the received encoded video data 8, such as a coded block, according to an entropy coding methodology, such as CAVLC or CABAC, to obtain the quantized coefficients. Video decoder 30 applies inverse quantization (de-quantization) and inverse transform functions to reconstruct the residual block in the pixel domain. Video decoder 30 also generates a prediction block based on control information or syntax information (e.g., coding mode, motion vectors, syntax that defines filter coefficients and the like) included in the encoded video data.

Additionally, video decoder 30 can check an IVRP flag for a current block to determine if the current block is coded using IVRP, assuming that video decoder 30 has determined that IVRP is available. In cases where video decoder 30 determines that IVRP is not available for a current block, video decoder 30 may infer (that is, determine without actually coding) that the IVRP flag has a value indicating that IVRP is not used to code the current block. In one example, video decoder 30 can infer if the current block is coded using IVRP based on whether the current block is inter-view predicted. In some examples, video decoder 30 may infer the value of the IVRP flag only after determining that IVRP is available for the current block. If video decoder 30 determines that IVRP is not available, video decoder 30 may avoid coding the current block using IVRP even if the reference block for skip or merge mode was coded using IVRP. In the event that video decoder 30 determines that the current block is coded using IVRP, video decoder 30 can reconstruct the block by adding the pixel values associated with a predicted block (PB) for the current block, to residual values associated with a residual reference block (RRB) (identified using a disparity vector calculated based on depth values associated with the current block), plus the residual values of the current block (CB_{R}), which video decoder 30 reconstructs using inverse quantization and inverse transformation. As noted above, in general, video decoder 30 can be configured to employ any of the foregoing IVRP availability checking and coding techniques described as executed by executed by video encoder 20. In any event, video decoder 30 can calculate a sum of the prediction block, the reconstructed residual block, and, when IVRP is available and used, the residual reference block, to produce a reconstructed video block for display at display device 32.

Display device 32 displays the decoded video data to a user including, e.g., multi-view video including destination view(s) synthesized based on depth information included in a reference view or views. Display device 32 can include any of a variety of one or more display devices such as a cathode ray tube (CRT), a liquid crystal display (LCD), a plasma display, an organic light emitting diode (OLED) display, or another type of display device. In some examples, display device 32 corresponds to a device capable of three-dimensional playback. For example, display device 32 may include a stereoscopic display, which is used in conjunction with eyewear worn by a viewer. The eyewear may include active glasses, in which case display device 30 rapidly alternates between images of different views synchronously with alternate shuttering of lenses of the active glasses. Alternatively, the eyewear may include passive glasses, in which case display device 32 displays images from different views simultaneously, and the passive glasses may include polarized lenses that are generally polarized in orthogonal directions to filter between the different views.

Video encoder 20 and video decoder 30 may operate according to a video coding standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video coding standards include MPEG-2 and ITU-T H.263. Although not shown in FIG. 1, in some cases, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. The Joint Video Team (JVT) continues to work on extensions to H.264/MPEG-4 AVC.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luminance (luma) and chrominance (chroma) samples. Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

A leaf-CU having one or more PUs may also include one or more transform units (TUs). The transform units may be specified using an RQT (also referred to as a TU quadtree structure), as discussed above. For example, a split flag may indicate whether a leaf-CU is split into four transform units. Then, each transform unit may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Video encoder 20 may further send syntax data, such as block-based syntax data, frame-based syntax data, and GOP-based syntax data, to video decoder 30, e.g., in a frame header, a block header, a slice header, or a GOP header. The GOP syntax data may describe a number of frames in the respective GOP, and the frame syntax data may indicate an encoding/prediction mode used to encode the corresponding frame.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). A device including video encoder 20 and/or video decoder 30 may comprise an integrated circuit, a microprocessor, and/or a wireless communication device, such as a cellular telephone.

The illustrated system 10 of FIG. 1 is merely one example. Techniques for performing IVRP in accordance with this disclosure may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

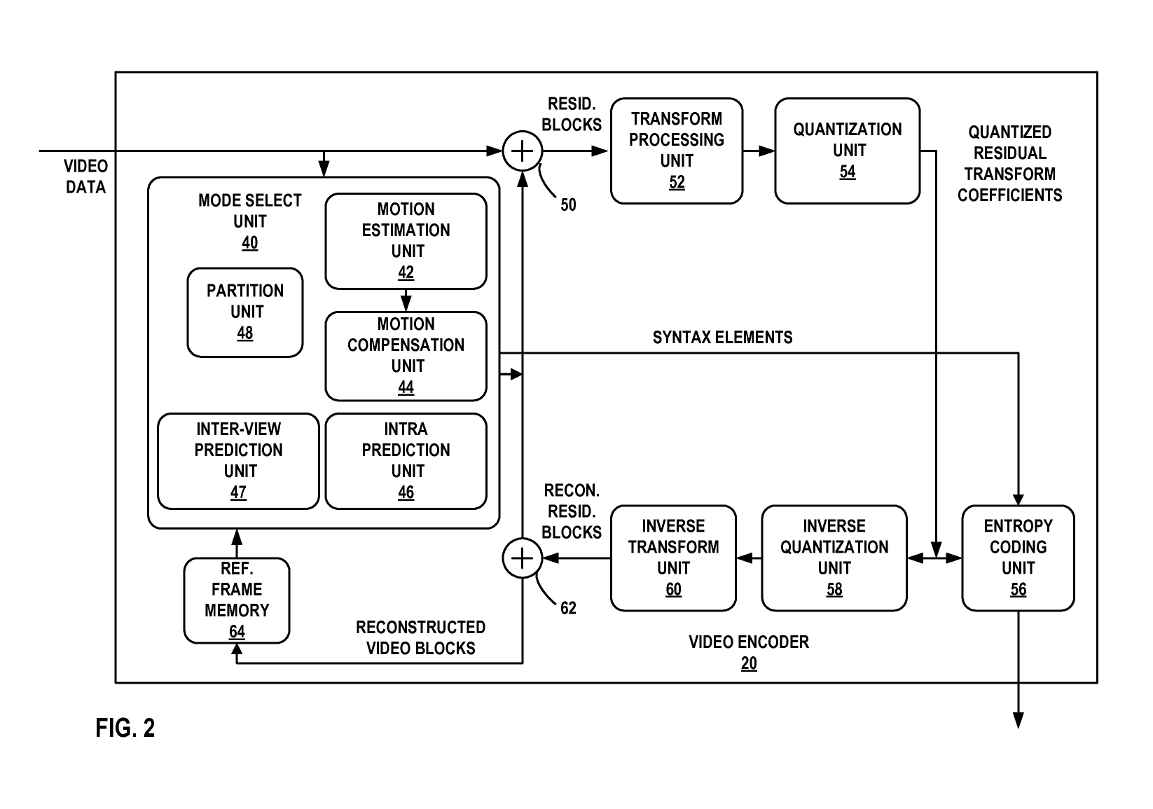

FIG. 2 is a block diagram illustrating an example of video encoder 20 that may implement techniques for performing IVRP in accordance with this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block within a video frame to be encoded. In the example of FIG. 2, video encoder 20 includes mode select unit 40, reference frame memory 64, summer 50, transform processing unit 52, quantization unit 54, and entropy coding unit 56. Mode select unit 40, in turn, includes motion compensation unit 44, motion estimation unit 42, intra-prediction unit 46, inter-view prediction unit 47, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and may provide the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy coding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference frame memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Motion compensation may include temporal motion compensation, which utilizes temporal reference pictures, or inter-view motion compensation (also referred to as disparity motion compensation), which utilizes inter-view reference pictures. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy coding unit 56. Entropy coding unit 56 may encode the information indicating the selected intra-prediction mode. Video encoder 20 may include configuration data in the transmitted bitstream. The configuration data can include intra-prediction mode index tables and modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54.

Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy coding unit 56 entropy codes the quantized transform coefficients. For example, entropy coding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy coding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame memory 64. The reconstructed video block may be used by motion estimation unit 42 and motion compensation unit 44 as a reference block to inter-code a block in a subsequent video frame.

Video encoder 20 also includes inter-view prediction unit 47, which may be configured to execute some or all of the IVRP availability checking and coding techniques described above with reference to FIG. 1. For example, inter-view prediction unit 47 can be configured to determine a disparity vector for a current block of video data in a current view based on depth information for the current block. Inter-view prediction unit 47 also determines a value of a CBF for a residual reference block of video data in a reference view. The disparity vector determined by inter-view prediction unit 47 identifies the residual reference block relative to the current block. Inter-view prediction unit 47 can be configured to code the current block using IVRP only when the value of the CBF indicates that the residual reference block includes at least one non-zero coefficient. Inter-view prediction unit 47, or another component of video encoder 20, can also be configured to employ other techniques in accordance with this disclosure, including, e.g. disabling IVRP coding when a block is inter-view predicted, using POC values to determine whether IVRP is available, applying IVRP to PUs rather than CUs, inferring values of IVRP flags when a block is skip or merge mode coded, using an IVRP flag of a neighboring block to determine context for CABAC coding an IVRP flag of a current block, and avoiding resetting of samples of a residual reference block to zeros during generation.

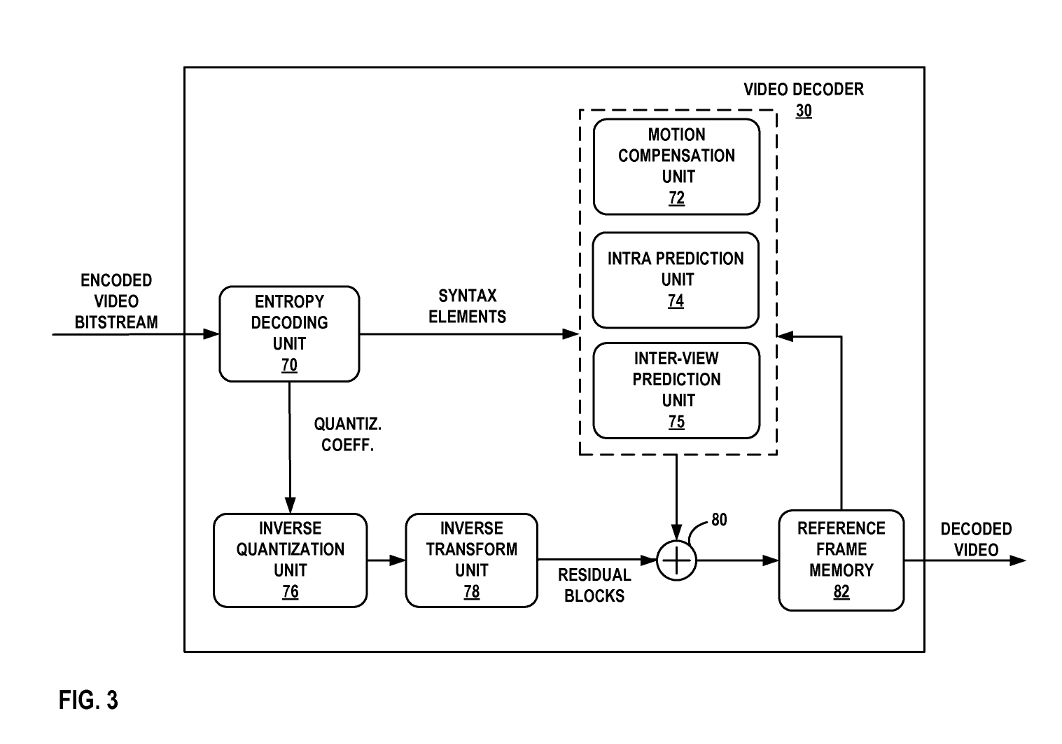

FIG. 3 is a block diagram illustrating an example of video decoder 30 that may implement techniques for performing IVRP. In the example of FIG. 3, video decoder 30 includes an entropy decoding unit 70, motion compensation unit 72, intra prediction unit 74, inter-view prediction unit 75, inverse quantization unit 76, inverse transformation unit 78, reference frame memory 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference frame memory 92. Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 80. The inverse quantization process may include use of a quantization parameter QP_{Y} calculated by video decoder 30 for each video block in the video slice to determine a degree of quantization and, likewise, a degree of inverse quantization that should be applied.

Inverse transform unit 78 applies an inverse transform, e.g., an inverse DCT, an inverse integer transform, or a conceptually similar inverse transform process, to the transform coefficients in order to produce residual blocks in the pixel domain.

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 92, which stores reference pictures used for subsequent motion compensation. Reference frame memory 82 also stores decoded video for later presentation on a display device, such as display device 32 of FIG. 1.

Video decoder 30 also includes inter-view prediction unit 75, which may be configured to execute some or all of the IVRP availability checking and coding techniques described above with reference to FIG. 1. For example, inter-view prediction unit 75 can be configured to check an IVRP flag for a current block to determine if the current block is coded using IVRP. In one example, inter-view prediction unit 75 can infer if the current block is coded using IVRP based on whether the current block is inter-view predicted. Inter-view prediction unit 75, or another component of video decoder 30 can also be configured to employ other techniques in accordance with this disclosure, including, e.g., using POC values to determine whether IVRP is available, applying IVRP to PUs rather than CUs, inferring values of IVRP flags when a block is skip or merge mode coded, using an IVRP flag of a neighboring block to determine context for a CABAC coded IVRP flag of a current block, and avoiding resetting of samples of a residual reference block to zeros during generation.

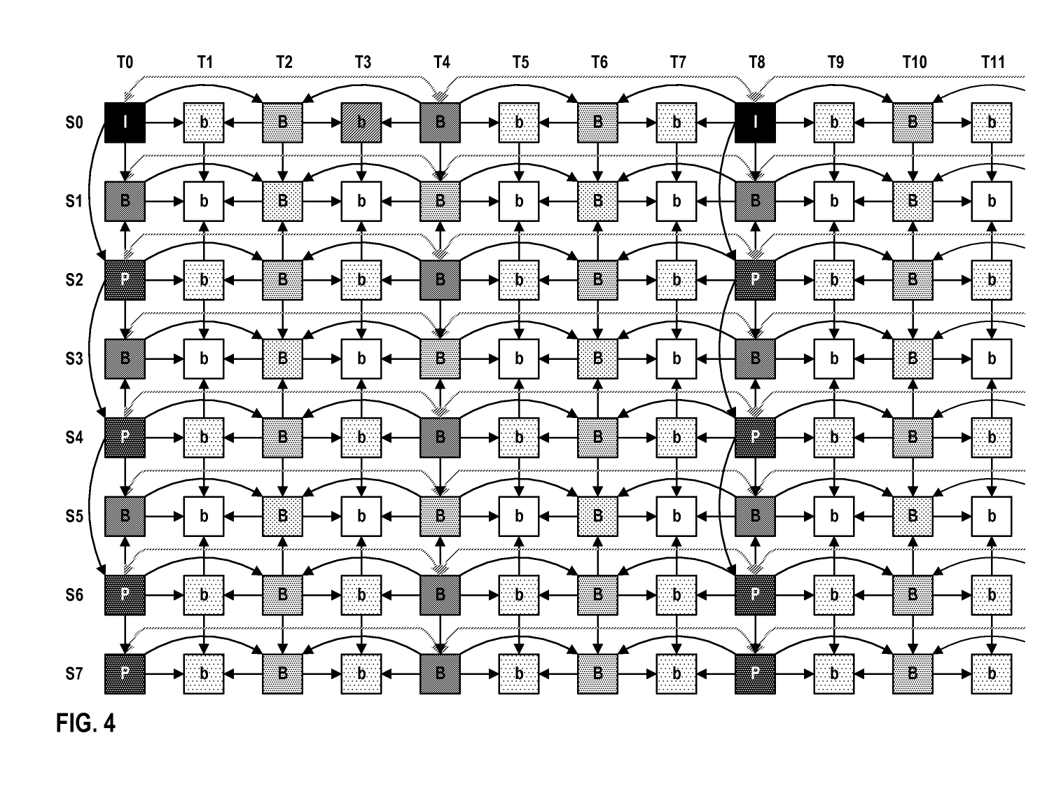

FIG. 4 is a conceptual diagram illustrating an example MVC prediction pattern. Multi-view video coding (MVC) is an extension of ITU-T H.264/AVC. A similar technique may be applied to HEVC. In the example of FIG. 4, eight views (having view IDs “S0” through “S7”) are illustrated, and twelve temporal locations (“T0” through “T11”) are illustrated for each view. That is, each row in FIG. 4 corresponds to a view, while each column indicates a temporal location.

Although MVC has a so-called base view which is decodable by H.264/AVC decoders and stereo view pair could be supported also by MVC, one advantage of MVC is that it could support an example that uses more than two views as a 3D video input and decodes this 3D video represented by the multiple views. A renderer of a client having an MVC decoder may expect 3D video content with multiple views.

A typical MVC decoding order is referred to as time-first coding. An access unit may include coded pictures of all views for one output time instance. For example, each of the pictures of time T0 may be included in a common access unit, each of the pictures of time T1 may be included in a second, common access unit, and so on. The decoding order is not necessarily identical to the output or display order.

Frames in FIG. 4 are indicated at the intersection of each row and each column in FIG. 4 using a shaded block including a letter, designating whether the corresponding frame is intra-coded (that is, an I-frame), or inter-coded in one direction (that is, as a P-frame) or in multiple directions (that is, as a B-frame). In general, predictions are indicated by arrows, where the pointed-to frame uses the pointed-from object for prediction reference. For example, the P-frame of view S2 at temporal location TO is predicted from the I-frame of view S0 at temporal location T0.

As with single view video encoding, frames of a multiview video coding video sequence may be predictively encoded with respect to frames at different temporal locations. For example, the b-frame of view S0 at temporal location T1 has an arrow pointed to it from the I-frame of view S0 at temporal location T0, indicating that the b-frame is predicted from the I-frame. Additionally, however, in the context of multiview video encoding, frames may be inter-view predicted. That is, a view component can use the view components in other views for reference. In MVC, for example, inter-view prediction is realized as if the view component in another view is an inter-prediction reference. The potential inter-view references are signaled in the Sequence Parameter Set (SPS) MVC extension and can be modified by the reference picture list construction process, which enables flexible ordering of the inter-prediction or inter-view prediction references.

In the MVC extension of H.264/AVC, as an example, inter-view prediction is supported by disparity motion compensation, which uses the syntax of the H.264/AVC motion compensation, but allows a picture in a different view to be used as a reference picture. Coding of two views can be supported by MVC, which is generally referred to as stereoscopic views. One of the advantages of MVC is that an MVC encoder could take more than two views as a 3D video input and an MVC decoder can decode such a multiview representation. So a rendering device with an MVC decoder may expect 3D video contents with more than two views.

In MVC, inter-view prediction (IVP) is allowed among pictures in the same access unit (that is, with the same time instance). An access unit is, generally, a unit of data including all view components (e.g., all NAL units) for a common temporal instance. Thus, in MVC, inter-view prediction is permitted among pictures in the same access unit. When coding a picture in one of the non-base views, the picture may be added into a reference picture list, if it is in a different view but with the same time instance (e.g., the same POC value, and thus, in the same access unit). An inter-view prediction reference picture may be put in any position of a reference picture list, just like any inter-prediction reference picture.

In the context of multi-view video coding, there are two kinds of motion vectors: normal motion vectors pointing to temporal reference pictures and disparity vectors pointing to pictures in a different view.

FIG. 4 provides various examples of inter-view prediction. Frames of view S1, in the example of FIG. 4, are illustrated as being predicted from frames at different temporal locations of view S1, as well as inter-view predicted from frames of frames of views S0 and S2 at the same temporal locations. For example, the b-frame of view S1 at temporal location T1 is predicted from each of the B-frames of view S1 at temporal locations T0 and T2, as well as the b-frames of views S0 and S2 at temporal location T1.

In the example of FIG. 4, capital “B” and lowercase “b” are intended to indicate different hierarchical relationships between frames, rather than different encoding methodologies. In general, capital “B” frames are relatively higher in the prediction hierarchy than lowercase “b” frames. FIG. 4 also illustrates variations in the prediction hierarchy using different levels of shading, where a greater amount of shading (that is, relatively darker) frames are higher in the prediction hierarchy than those frames having less shading (that is, relatively lighter). For example, all I-frames in FIG. 4 are illustrated with full shading, while P-frames have a somewhat lighter shading, and B-frames (and lowercase b-frames) have various levels of shading relative to each other, but always lighter than the shading of the P-frames and the I-frames.

In general, the prediction hierarchy is related to view order indexes, in that frames relatively higher in the prediction hierarchy should be decoded before decoding frames that are relatively lower in the hierarchy, such that those frames relatively higher in the hierarchy can be used as reference frames during decoding of the frames relatively lower in the hierarchy. A view order index is an index that indicates the decoding order of view components in an access unit. The view order indices are implied in the SPS MVC extension, as specified in Annex H of H.264/AVC (the MVC amendment). In the SPS, for each index i, the corresponding view_id is signaled. In some examples, the decoding of the view components shall follow the ascending order of the view order index. If all the views are presented, then the view order indexes are in a consecutive order from 0 to num_views_minus 1.

In this manner, frames used as reference frames may be decoded before decoding the frames that are encoded with reference to the reference frames. A view order index is an index that indicates the decoding order of view components in an access unit. For each view order index i, the corresponding view_id is signaled. The decoding of the view components follows the ascending order of the view order indexes. If all the views are presented, then the set of view order indexes may comprise a consecutively ordered set from zero to one less than the full number of views.

For certain frames at equal levels of the hierarchy, decoding order may not matter relative to each other. For example, the I-frame of view S0 at temporal location T0 is used as a reference frame for the P-frame of view S2 at temporal location T0, which is in turn used as a reference frame for the P-frame of view S4 at temporal location T0. Accordingly, the I-frame of view S0 at temporal location T0 should be decoded before the P-frame of view S2 at temporal location T0, which should be decoded before the P-frame of view S4 at temporal location T0. However, between views S1 and S3, a decoding order does not matter, because views S1 and S3 do not rely on each other for prediction, but instead are predicted only from views that are higher in the prediction hierarchy. Moreover, view S1 may be decoded before view S4, so long as view S1 is decoded after views S0 and S2.

In this manner, a hierarchical ordering may be used to describe views S0 through S7. Let the notation SA>SB mean that view SA should be decoded before view SB. Using this notation, S0>S2>S4>S6>S7, in the example of FIG. 4. Also, with respect to the example of FIG. 4, S0>S1, S2>S1, S2>S3, S4>S3, S4>S5, and S6>S5. Any decoding order for the views that does not violate these requirements is possible. Accordingly, many different decoding orders are possible, with only certain limitations.

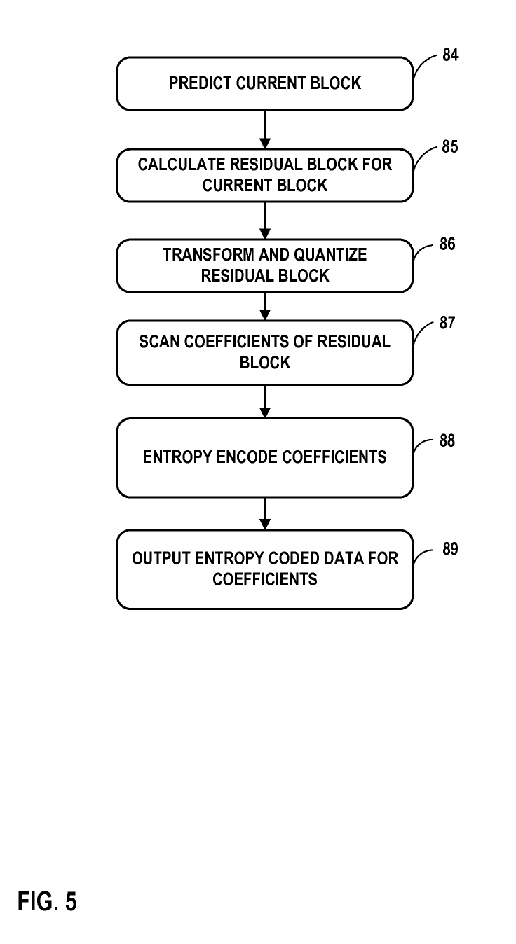

FIG. 5 is a flowchart illustrating an example method for encoding a current block. The current block may comprise a current CU or a portion of the current CU. Although described with respect to video encoder 20 (FIGS. 1 and 2), it should be understood that other devices may be configured to perform a method similar to that of FIG. 5.

In this example, video encoder 20 initially predicts the current block (84). For example, video encoder 20 may calculate one or more prediction units (PUs) for the current block. Video encoder 20 may then calculate a residual block for the current block, e.g., to produce a transform unit (TU) (85). To calculate the residual block, video encoder 20 may calculate a difference between the original, uncoded block and the predicted block for the current block. Video encoder 20 may then transform and quantize coefficients of the residual block (86). Next, video encoder 20 may scan the quantized transform coefficients of the residual block (87). During the scan, or following the scan, video encoder 20 may entropy encode the coefficients (88). For example, video encoder 20 may encode the coefficients using CAVLC or CABAC. Video encoder 20 may then output the entropy coded data of the block (89).

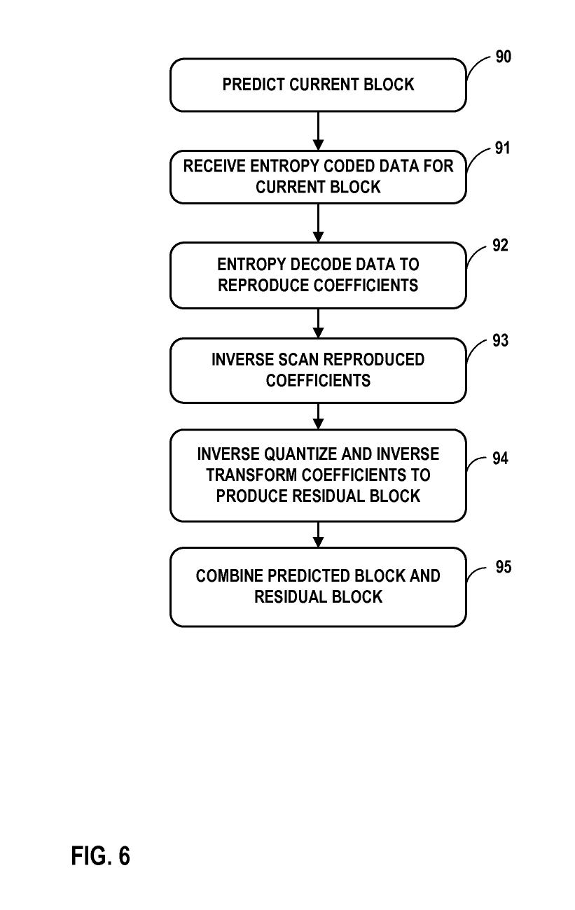

FIG. 6 is a flowchart illustrating an example method for decoding a current block of video data. The current block may comprise a current CU or a portion of the current CU. Although described with respect to video decoder 30 (FIGS. 1 and 3), it should be understood that other devices may be configured to perform a method similar to that of FIG. 6.

Video decoder 30 may predict the current block (90), e.g., using an intra- or inter-prediction mode to calculate a predicted block for the current block. Video decoder 30 may also receive entropy coded data for the current block, such as entropy coded data for coefficients of a residual block corresponding to the current block (91). Video decoder 30 may entropy decode the entropy coded data to reproduce coefficients of the residual block (92). Video decoder 30 may then inverse scan the reproduced coefficients (93), to create a block of quantized transform coefficients. Video decoder 30 may then inverse quantize and inverse transform the coefficients to produce a residual block (94). Video decoder 30 may ultimately decode the current block by combining the predicted block and the residual block (95).

As described above, coding video data, whether encoding by video encoder 20 in accordance with the example method of FIG. 5 or decoding by video decoder 30 in accordance with the example method of FIG. 6, can include checking the availability of and coding residual information for a current block using IVRP. A process that includes IVRP availability checking and coding in accordance with this disclosure is illustrated in and described with reference to FIGS. 7-9 below.

FIG. 7 is a flowchart illustrating an example method of coding a block of video data in accordance with this disclosure. The example of FIG. 7 includes determining the availability of IVRP for coding the block of video data. The method of FIG. 7 includes determining a disparity vector for a current block of video data in a current view based on depth information for the current block (96), determining a value of a CBF for a residual reference block of video data in a reference view (97), and coding the current block using inter-view residual prediction only when the value of the coded block flag indicates that the residual reference block includes at least one non-zero coefficient (98). The disparity vector identifies the residual reference block relative to the current block.

The functions of the example method of FIG. 7 can be carried out by a number of different devices, including, e.g., video encoder 20 of FIGS. 1 and 2 and/or video decoder 30 of FIGS. 1 and 3. However, for purposes of illustration, the functions of the example method of FIG. 5 and other related functions of IVRP availability checking and coding are described below as executed by video encoder 20, and, in particular, by inter-view prediction unit 47 of encoder 20.

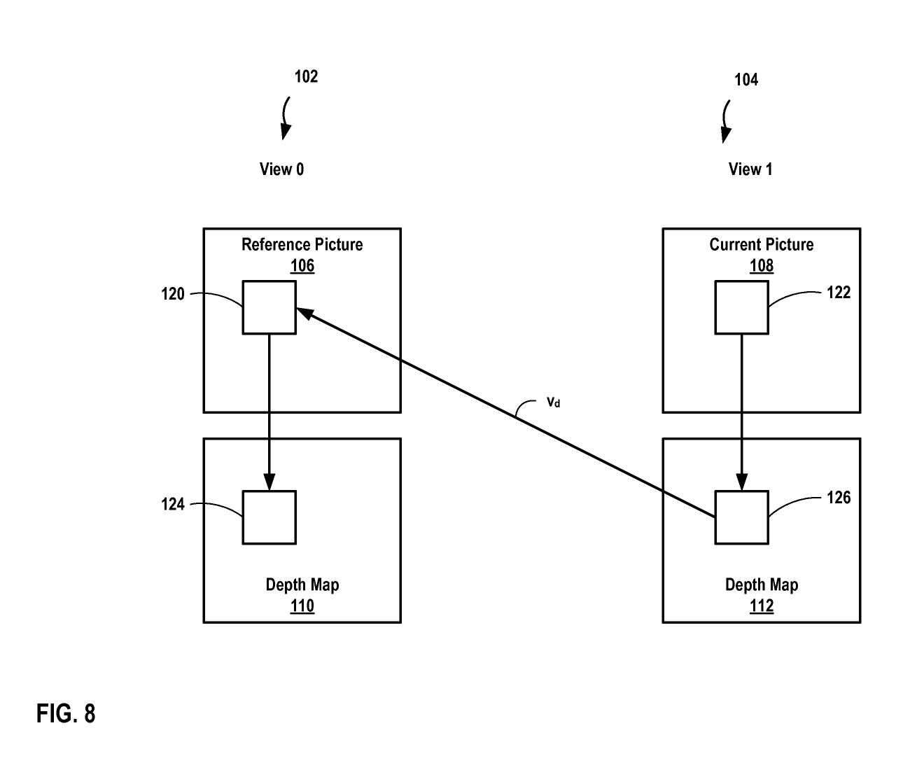

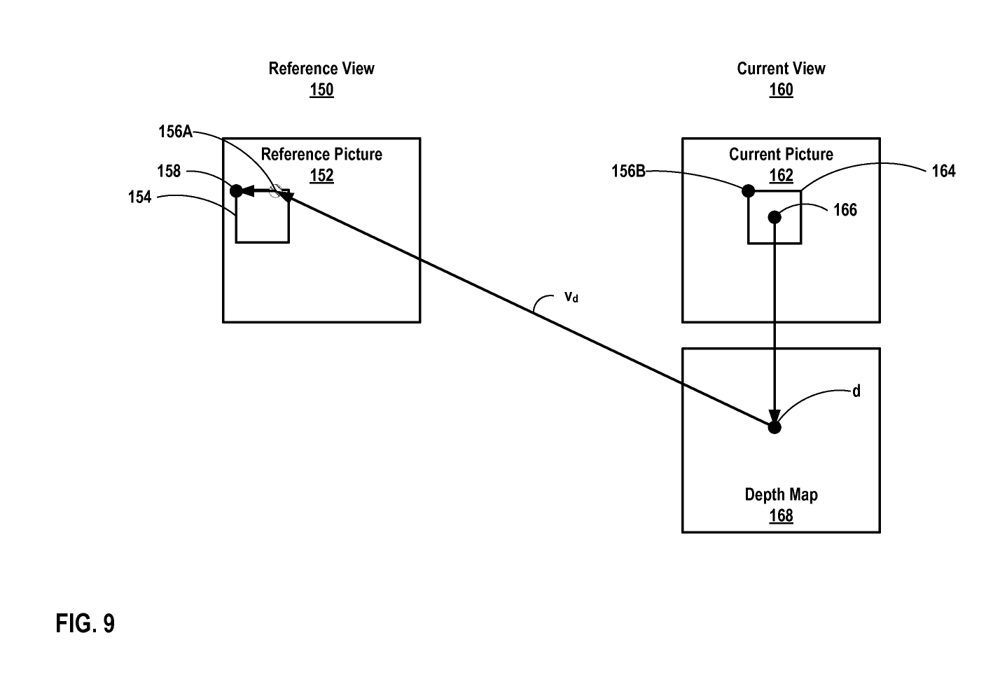

IVRP availability checking in accordance with this disclosure includes determining a value of CBF of a for a residual reference block of video data in a reference view. The residual reference block is identified by a disparity vector for a current block of video data in a current view, which is determined based on depth information for the current block. FIGS. 8 and 9 are conceptual diagrams illustrating aspects of IVRP availability checking and coding, including disparity vector determinations and residual reference block identification.

FIG. 8 is a conceptual diagram illustrating an example of IVRP. The example of FIG. 8 illustrates pictures 106, 108 and depth maps 110, 112 of views 102, 104 (where view 102 is also labeled “View 0” and view 104 is also labeled “View 1” in FIG. 8). Blocks 120, 122, 124, and 126 are included in and generally correspond to pictures 106, 108 and depth maps 110, 112, respectively. Depth maps 110, 112 may generally be coded as pictures having only luminance data, without chrominance data, such that pixel values in the depth map correspond to depth values of corresponding texture information, where texture information may include chrominance and/or luminance information of, e.g., pictures 106, 108.

FIG. 8 provides an overview of principles of IVRP. In one example, picture 108 represents a current picture and picture 106 represents a reference picture for IVRP of picture 108. Based on a related depth map 112 (or estimated depth map) of current picture 108, a disparity vector, v_{d}, is determined for current block 122. The disparity vector, v_{d}, identifies residual reference block 120 in the reference view 102. Residual reference block 120 corresponds to residual block 124 in depth map 110 associated with reference picture 106. Residual information included in residual block 124 can be employed by, e.g., inter-view prediction unit 47 of encoder 20 to predict residual data for current block 122 as part of IVRP coding current block 122.

FIG. 9 is a conceptual diagram illustrating another example of inter-view residual prediction, which portrays a relatively more detailed description of deriving a location of a reference block inside a reference picture of a reference view. In this example, view 150 includes picture 152, while view 160 includes picture 162 and depth map 168. In this example, view 160 is a current view in the sense that view 160 is a current view being coded, while view 150 is a reference view from which one or more blocks of current view 160 are predicted. Picture 162 is a current picture in current view 160. Picture 152 is a reference picture in reference view 150. Depth map 168 may be an estimated depth map for current picture 162 in current view 160 or an actual depth map (which may be encoded and decoded).

In accordance with the example method of FIG. 7, inter-view prediction unit 47 of encoder 20 can determine disparity vector, v_{d}, for current block 164 of current picture 162 in current view 160 based on depth information, d, in depth map 168. In one example, inter-view prediction unit 47 can identify current block 164 by a pixel (e.g., a sample) in the upper-left corner, shown as top-left sample 156B in FIG. 9. Top-left sample 156B is collocated with position 156A, and thus, position 156A in reference view 150 corresponds to top-left sample 156B in current view 162. Inter-view prediction unit 47 can also select sample location 166 in the middle of current block 164 to locate depth value, d, which is collocated with sample location 166 in depth map 168, assuming depth map 168 and current picture 162 have the same spatial resolution. If the depth map and current picture do not have the same spatial resolution, a video coder may calculate a scale between the current picture and the depth map to determine a depth value that corresponds to sample location 166.

Inter-view prediction unit 47 can convert depth value(s) to disparity vector, v_{d}. Additionally, inter-view prediction unit 47 can add disparity vector, v_{d}, to the location of top-left sample 156B of current block 164 to identify the location of top-left sample 158 of reference block 154. In this manner, reference block 154 may be identified based on the position of top-left sample 156 and depth value, d, that corresponds to sample location of current block 166.

Thus, reference block 154 may be used for residual prediction of current block 164. That is, similar to motion compensation, samples (that is, pixels) in residual reference block 154 may be subtracted from the residual for current block 164, and only the resulting difference signal (that is, pixel-by-pixel differences) may be transform coded. If the disparity vector points to a sub-sample location, the values of samples of residual reference block 154 may be obtained by interpolating the residual samples of reference view 150 using a bi-linear filter or other appropriate filter.

In the current working draft of HEVC, usage of inter-view residual prediction can be adaptively selected on a block-by-block basis, or on a coding unit (CU) basis. For that purpose, if any sample of the residual reference block (e.g., block 154) is not equal to 0, residual reference block 154 may be marked as available. When a residual reference block is available, a flag (e.g., referred to as a “residual prediction flag”) may indicate that the usage of inter-view residual prediction is CABAC coded with no context modeling in CU syntax. If this flag is equal to 1, the current residual signal may be predicted using residual reference block 154 and the difference may be transmitted using transform coding. Otherwise, the residue of the current block may be conventionally coded using, e.g., HEVC transform coding.

Note that to determine the availability of residual reference block, it has to be generated first. The generation process requires de-quantization, inverse transform, and potentially interpolation. Moreover, when a part of residual reference block is covered by an intra-coded or inter-view predicted block, the samples of that part are reset to zero, in the current working draft of HEVC.

This disclosure provides techniques for checking (that is, determining) whether IVRP is available based on a value of a CBF for a block. To avoid undesired operations like interpolation at the bitstream parsing stage, the residual reference block reconstruction based IVRP availability checking is replaced by CBF based IVRP availability checking in accordance with this disclosure. For example, after inter-view prediction unit 47 locates residual reference block 154 in reference view 150, certain sized coded blocks of reference picture 152, e.g., 4×4 blocks that together cover the whole residual reference block 154 can be identified. Residual reference block 154 does not necessarily align perfectly with one of the coded blocks of reference picture 150, but may occur at any arbitrary point in the reference picture. As such, inter-view prediction unit 47 may need to determine the CBF value for more than one coded block of reference picture 150 that overlaps with residual reference block 154.

Among the coded blocks overlapping residual reference block 154, if inter-view prediction unit 47 determines that there is an inter-coded block that also contains a non-zero CBF (either luma or chroma CBF), inter-view prediction unit 47 can mark the related block as available. Otherwise, IVRP may not be applied to this block, and thus, no IVRP flag needs to be coded. In such a situation in which inter-view prediction unit 47 needs to determine the value of multiple CBFs associated with multiple coded blocks of reference picture 150 overlapping residual reference block 154, inter-view prediction unit 47 may determine that IVRP coding is available only when the coded block flags of all of the coded blocks overlapping with residual reference block 154 indicate that the each coded block includes at least one non-zero coefficient.

The following pseudocode provides a function “check_IVRP_availability( )” that may be used to implement some or all of the foregoing example:

```
bool check_IVRP_availability( )
{
Get disparity vector V_{D} of the current CU
      Based on V_{D}, get the top-left position (X₀, Y₀) of the residual
            reference block in the reference view
for (x=0; x <CUWidth + (Is X₀ not integer pixel aligned?); x+=4)
{
      for (y=0; y<CUHeight; y+=4)
      {
            if(the 4×4 block which covers (X₀+x,Y₀+y) in the
                  reference view is intra coded)
                  continue;
            if(the 4×4 block which covers (X₀+x,Y₀+y) in the
                  reference view contains non-zero luma CBF
                  or non-zero chroma CBF)
            return true;
      }
}
return false;
}
```

In one example in which the residual reference block is identified based on a disparity vector that has fractional pixel precision, the top-left position (e.g., the top left pixel) of the current block, CU, is denoted by coordinates (x, y). Inter-view prediction unit 47 can use disparity (dis), which may be fractionally accurate (that is, have fractional pixel precision). Inter-view prediction unit 47 can determine a co-located area of a reference picture, from which the residual is predicted, by the top-left and bottom-right pixel locations:

(x₀,y₀)=(x+dis,y), where (x₀,y₀) represents the upper-left corner of the reference block; and

(x₁,y₁)=(x+dis+CUWidth−1,y+CUHeight−1), where (x₁,y₁) represents the lower-right corner of the reference block, and where (CUWidth, CUHeight) is the size of the current CU.

Since (x₀, y₀) and (x₁, y₁) might not be integer positions, the coordinates may be converted to integer values in one example as follows:

x₀=floor(x₀)

x₁=ceil(x₁)

Alternatively, in another example, the coordinates can be converted as follows:

x₀=floor(x₀)

x₁=CUWidth−1+x₀

Alternatively, in yet another example, the coordinates can be converted as follows:

x₁=ceil(x₁)

x₀=x₁−CUWidth+1

After applying one of these conversions, the region identified by (x0, y0) and (x1, y1) is referred to as the corresponding relevant region, or the residual reference block.

In accordance with the techniques of this disclosure, inter-view prediction unit 47 can traverse a transform tree (e.g., an RQT) for coding modes and CBF values of a CU. Inter-view prediction unit 47 can check CBF values and intra/inter coding modes of TUs of a CU according to a certain order, which may include but is not necessarily limited to TU decoding order, raster order, or the order of quadtree scanning. If inter-view prediction unit 47 determines that one of the scanned TUs of the CU is inter-coded and contains a non-zero CBF value (luma CBF or chroma CBF), inter-view prediction unit 47 can mark the related residual reference as available and residual prediction may be applied. Otherwise, inter-view prediction unit 47 may not apply IVRP to this CU. When residual prediction is available (e.g., may be applied) for a CU, inter-view prediction unit 47 can code (e.g., signal or interpret) an IVRP flag indicative of whether IVRP is used for the CU.

As one example, inter-view prediction unit 47 can perform steps according to the following method to determine whether IVRP is available for a particular CU:
1. Identify each transform tree for the CU that covers at least a portion of a corresponding relevant region
2. For each leaf node of each transform tree:
   a. If the leaf node corresponds to a PU that is inter-coded and the leaf node contains a non-zero luma CBF or a non-zero chroma CBF, return true (indicating that IVRP is available). This also terminates the method.
3. Return false (indicating that IVRP is not available).

As another, alternative example, inter-view prediction unit 47 can perform steps according to the following method to determine whether IVRP is available for a particular CU:
1. Set a previous TU (PTU) as unavailable
2. For each 4×4 block in the corresponding relevant region checked in a particular TU scan order (e.g., raster scan order):
   a. If PTU is available and the current block belongs to the same TU as the previous TU, continue;
   b. Otherwise:
      i. Set the PTU to the TU to which the current 4×4 block belongs to true
      ii. If the current TU belongs to an inter-coded PU and the CBF value for any component (luma, Cb, or CR) is true, return true (indicating that IVRP is available);
3. Return false (indicating that IVRP is not available).

When the methods in the above two examples return true, inter-view prediction unit 47 may (but does not necessarily) apply IVRP to the CU. Thus, when the methods above return true, residual prediction is available, and inter-view prediction unit 47 can code an IVRP flag indicating whether IVRP is applied to the CU. On the other hand, when the methods of the above two examples return false, inter-view prediction unit 47 need not code an IVRP flag, as it may be determined that IVRP is not available.

In addition to the foregoing IVRP availability checking and coding techniques, inter-view prediction unit 47 of video encoder 20 may be configured to employ a number of related techniques to improve efficiency. Generally speaking IVRP and inter-view prediction are highly overlapped. As such, when predicting predicted block of a current block is inter-view predicted it may be inferred that it is advisable to disable IVRP for the current block. In one example, a reference block corresponds to (e.g., overlaps with) one or more coded blocks in a reference picture and each coded block corresponds to a CU including multiple PUs. In one example, inter-view prediction unit 47 can mark a CU in the reference picture as unavailable for IVRP if at least one PU of the CU is coded using inter-view prediction.

In some examples, the determination of whether IVRP is available can be further simplified by inter-view prediction unit 47 first determining whether the POC value of the temporal reference picture of the current block is the same as the POC value of the temporal reference picture of the residual reference block. The POC values of these pictures will only be the same when performing IVRP. Thus, if these POC values are different, the video coder need not check whether IVRP is available, because if these POC values are different, this indicates that IVRP is not being used.

POC information generally corresponds to display order information for a picture of video data. In one example, POC_{ResPRef} denotes the POC of the temporal reference picture of a residual reference block, and POC_{Ref} represents the POC of the temporal reference picture of the current block. In one such an example, inter-view prediction unit 47 may mark a residual reference block as unavailable for IVRP when POC_{ResPRef}≠POC_{Ref}, that is, when POC_{ResPRef} is not equal to POC_{Ref}.

As described above, a coded block of video data can be a number of different sizes. In some cases, a coded block of video data is referred to as a coding unit (CU). Each CU includes a number of sub-blocks of coded data referred to as prediction units (PUs). Different PUs in one CU can have quite different depth information. As such, inter-view prediction unit 47 can, in some examples, be configured to apply IVRP at the PU versus the CU level. For example, inter-view prediction unit 47 can check IVRP availability and signal an IVRP flag at the PU level. Additionally, inter-view prediction unit 47 can be configured to determine disparity vectors and locate residual reference data in a reference view based thereon at the PU versus CU level.

Referring again to the example illustrated in FIG. 9, inter-view prediction unit 47 of encoder 20 determines disparity vector, v_{d}, for current block 164 of current picture 162 in current view 160 based on depth information, d, in depth map 168. Depth value(s), d, are collocated, in depth map 168, with sample location 166 at the center of current block 164. However, in the event a current block corresponds to a CU including multiple PUs and IVRP is applied at the PU versus the CU level, a different technique can be used to determine disparity vectors and locate residual reference information based thereon. In one example, inter-view prediction unit 47 can identify can select a sample location in the middle of each PU of the CU to locate a corresponding depth value(s) of each PU in the depth map corresponding to the current picture including the CU. Additionally, inter-view prediction unit 47 can determine a disparity vector for each PU based on the depth value(s) for the PU.

In one example in which IVRP is applied at the PU level, inter-view prediction unit 47 is configured to determine a first disparity vector corresponding to a first prediction unit (PU) of a CU and determine a second disparity vector corresponding to a second PU of the CU. Inter-view prediction unit 47 can then locate a first residual reference block in a reference view using the first disparity vector relative to a center of the first PU, and locate a second residual reference block in the reference view using the second disparity vector relative to a center of the second PU. Additionally, inter-view prediction unit 47 can determine a value of a first coded block flag for the first residual reference block, and determine a value of a second coded block flag for the second residual reference block. To apply IVRP coding at the PU level, in one example, inter-view prediction unit 47 codes the first PU using inter-view residual prediction only when the value of the first coded block flag indicates that the first residual reference block includes at least one non-zero coefficient, and codes the second PU using inter-view residual prediction only when the value of the second coded block flag indicates that the second residual reference block includes at least one non-zero coefficient.

In one example, inter-view prediction unit 47 is configured to infer a value for an IVRP flag of a current block being skip or merge mode coded. For skip and merge modes, motion information is inferred from predefined candidates. For example, if a reference block, from which inter-view prediction unit 47 predicts motion information in skip or merge mode, has a particular value for its IVRP flag, then inter-view prediction unit 47 can infer that the IVRP flag of the current block (being skip or merge mode coded) should have the same value.

In the event inter-view prediction unit 47 codes an IVRP flag for a block of video data in a current picture, inter-view prediction unit 47 can also be configured to improve CABAC coding of the IVRP flag by using the value of the IVRP flag of a neighboring block as the context to CABAC code the IVRP flag of the current block. For example, when the residual reference block of a neighboring block of the current block is available and the IVRP flag of the neighboring block is true, inter-view prediction unit 47 can set the context index for coding the current IVRP flag to 1. Otherwise, video encoder 20 can set the context index to 0. In one example, the neighboring block of the current block based upon which inter-view prediction unit 47 sets CABAC coding context of the IVRP flag of the current block is either the left or top neighboring block.

In one example according to this disclosure, inter-view prediction unit 47 is configured to avoid resetting residual reference block values to zero to simplify residual reference block generation. For example, inter-view prediction unit 47 can be configured to code a current block of video data in a current picture of a current view using IVRP without resetting any values of samples of a residual reference block of the current block to zero.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
determining a disparity vector for a current block of video data in a current view based on depth information for the current block, wherein the disparity vector indicates a location of a residual reference block of video data in a reference view relative to the current block;
determining a value of a coded block flag for the residual reference block; and
coding the current block using inter-view residual prediction only when the value of the coded block flag indicates that the residual reference block includes at least one non-zero coefficient.

2. The method of claim 1, further comprising coding a value of an inter-view residual prediction flag only when the value of the coded block flag indicates that the residual reference block includes at least one non-zero coefficient, wherein coding the current block using inter-view residual prediction comprises coding the current block using inter-view residual prediction based on the value of the inter-view residual prediction flag.

3. The method of claim 1, further comprising determining that the residual reference block overlaps with a plurality of coded blocks in the reference view, and wherein determining the value of the coded block flag for the residual reference block comprises determining a value of a coded block flag for each of the plurality of coded blocks in the reference view with which the residual reference block overlaps.

4. The method of claim 3, wherein coding the current block comprises coding the current block using inter-view residual prediction only when the value of each of the coded block flags of each of the plurality of coded blocks in the reference view indicates that the respective residual reference block includes at least one non-zero coefficient.

5. The method of claim 1, wherein the residual reference block comprises at least one of a luminance reference block and a chrominance reference block, and wherein determining the value of the coded block flag for the residual reference block comprises determining a value of a coded block flag for the at least one of a luminance reference block and a chrominance reference block.

6. The method of claim 1, wherein coding the current block comprises:
when the current block comprises a luminance block, coding the luminance block using inter-view residual prediction only when a value of a coded block flag for a luminance reference block of the residual reference block indicates that the luminance reference block includes at least one non-zero coefficient; and
when the current block comprises a chrominance block, coding the chrominance block only when a value of a coded block flag for a chrominance reference block of the residual reference block indicates that the chrominance reference block includes at least one non-zero coefficient.

7. The method of claim 1, wherein the current block corresponds to a predicted block of video data in the reference view, and further comprising:
determining a coding mode for the predicted block; and
coding the current block using inter-view residual prediction only when the coding mode for the predicted block is not inter-view prediction.

8. The method of claim 7, wherein the predicted block comprises a coding unit (CU) comprising a plurality of prediction units (PUs), and wherein coding the current block comprises coding the current block using inter-view residual prediction only when the coding modes for each of the PUs of the CU is not inter-view prediction.

9. The method of claim 1, wherein the current block is predicted relative to a first reference picture, wherein the residual reference block corresponds to a reference block predicted relative to a second reference picture, the method further comprising:
determining a first picture order count (POC) value for the first reference picture;
determining a second POC value for the second reference picture, and
wherein coding the current block using inter-view residual prediction comprises coding the current block using inter-view residual prediction only when the first POC value is equal to the second POC value.

10. The method of claim 1, wherein the current block comprises at least a portion of a current coding unit corresponding to a prediction unit of the current coding unit.

11. The method of claim 1, wherein the current block comprises a current coding unit (CU) comprising a plurality of prediction units (PUs), and wherein determining the disparity vector comprises:
determining a first disparity vector corresponding to a first prediction unit (PU) of the plurality of PUs; and
determining a second disparity vector corresponding to a second PU of the plurality of PUs.

12. The method of claim 11, further comprising:
locating a first residual reference block in the reference view using the first disparity vector relative to a center of the first PU; and
locating a second residual reference block in the reference view using the second disparity vector relative to a center of the second PU.

13. The method of claim 12, wherein determining the value of the coded block flag for the residual reference block comprises:
determining a value of a first coded block flag for the first residual reference block; and
determining a value of a second coded block flag for the second residual reference block.

14. The method of claim 12, wherein coding the current block comprises:
coding a first portion of the current CU corresponding to the first PU using inter-view residual prediction only when the value of the first coded block flag indicates that the first residual reference block includes at least one non-zero coefficient; and
coding a second portion of the current CU corresponding to the second PU using inter-view residual prediction only when the value of the second coded block flag indicates that the second residual reference block includes at least one non-zero coefficient.

15. The method of claim 14, further comprising:
coding a first inter-view residual prediction flag for the first PU; and
coding a second, different inter-view residual prediction flag for the second PU.

16. The method of claim 1, further comprising:
based on a determination that the current block is coded using skip mode or merge mode, applying motion information of a candidate block, identified by performing the skip mode or the merge mode coding, to the current block;
determining a value for an inter-view residual prediction flag for the candidate block; and
coding the current block using inter-view residual prediction when the inter-view residual prediction flag indicates that the candidate block is coded using inter-view residual prediction.

17. The method of claim 1, further comprising:
determining the value of the coded block flag for the residual reference block indicates that the residual reference block includes at least one non-zero coefficient;
determining a context for coding an inter-view residual prediction flag of the current block using context-adaptive binary arithmetic coding (CABAC) based on a value of an inter-view residual prediction flag of a neighboring block of the current block; and
coding the inter-view residual prediction flag of the current block using the determined context.

18. The method of claim 17, wherein the neighboring block comprises at least one of a top neighboring block or a left neighboring block of the current block.

19. The method of claim 18, wherein determining the context comprises:
when a residual reference block of the neighboring block is available and when the value of the inter-view residual prediction flag of the neighboring block is true, setting a context index for the context equal to 1; and
when the residual reference block of the neighboring block is not available, or when the value of the inter-view residual prediction flag of the left neighboring block is false, setting the context index equal to 0.

20. The method of claim 1, wherein coding the current block comprises coding the current block using inter-view residual prediction without resetting any values of samples of the residual reference block to zero.

21. A video coding device comprising a video coder configured to:
determine a disparity vector for a current block of video data in a current view based on depth information for the current block, wherein the disparity vector indicates a location of a residual reference block of video data in a reference view relative to the current block;
determine a value of a coded block flag for the residual reference block; and
code the current block using inter-view residual prediction only when the value of the coded block flag indicates that the residual reference block includes at least one non-zero coefficient.

22. The device of claim 21, wherein the video coder is configured to:
code a value of an inter-view residual prediction flag only when the value of the coded block flag indicates that the residual reference block includes at least one non-zero coefficient; and
code the current block using inter-view residual prediction based on the value of the inter-view residual prediction flag.

23. The device of claim 21, wherein the video coder is configured to:
determine that the residual reference block overlaps with a plurality of coded blocks in the reference view;
determine a value of a coded block flag for each of the plurality of coded blocks in the reference view with which the residual reference block overlaps.

24. The device of claim 23, wherein the video coder is configured to code the current block using inter-view residual prediction only when the value of each of the coded block flags of each of the plurality of coded blocks in the reference view indicates that the respective residual reference block includes at least one non-zero coefficient.

25. The device of claim 21, wherein the residual reference block comprises at least one of a luminance reference block and a chrominance reference block, and wherein the video coder is configured to determine a value of a coded block flag for the at least one of a luminance reference block and a chrominance reference block.

26. The device of claim 21, wherein the video coder is configured to:
when the current block comprises a luminance block, code the luminance block using inter-view residual prediction only when a value of a coded block flag for a luminance reference block of the residual reference block indicates that the luminance reference block includes at least one non-zero coefficient; and
when the current block comprises a chrominance block, code the chrominance block only when a value of a coded block flag for a chrominance reference block of the residual reference block indicates that the chrominance reference block includes at least one non-zero coefficient.

27. The device of claim 21, wherein the current block corresponds to a predicted block of video data in the reference view, and wherein the video coder is configured to:
determine a coding mode for the predicted block; and
code the current block using inter-view residual prediction only when the coding mode for the predicted block is not inter-view prediction.

28. The device of claim 27, wherein the predicted block comprises a coding unit (CU) comprising a plurality of prediction units (PUs), and wherein the video coder is configured to code the current block using inter-view residual prediction only when the coding modes for each of the PUs of the CU is not inter-view prediction.

29. The device of claim 21, wherein the current block is predicted relative to a first reference picture, wherein the residual reference block corresponds to a reference block predicted relative to a second reference picture, and wherein the video coder is configured to:
determine a first picture order count (POC) value for the first reference picture;
determine a second POC value for the second reference picture, and
code the current block using inter-view residual prediction only when the first POC value is equal to the second POC value.

30. The device of claim 21, wherein the current block comprises at least a portion of a current coding unit corresponding to a prediction unit of the current coding unit.

31. The device of claim 21, wherein the current block comprises a current coding unit (CU) comprising a plurality of prediction units (PUs), and wherein the video coder is configured to:
determine a first disparity vector corresponding to a first prediction unit (PU) of the plurality of PUs; and
determine a second disparity vector corresponding to a second PU of the plurality of PUs.

32. The device of claim 31, wherein the video coder is configured to:
locate a first residual reference block in the reference view using the first disparity vector relative to a center of the first PU; and
locate a second residual reference block in the reference view using the second disparity vector relative to a center of the second PU.

33. The device of claim 32, wherein the video coder is configured to:
determine a value of a first coded block flag for the first residual reference block; and
determine a value of a second coded block flag for the second residual reference block.

34. The device of claim 32, wherein the video coder is configured to:
code a first portion of the current CU corresponding to the first PU using inter-view residual prediction only when the value of the first coded block flag indicates that the first residual reference block includes at least one non-zero coefficient; and
code a second portion of the current CU corresponding to the second PU using inter-view residual prediction only when the value of the second coded block flag indicates that the second residual reference block includes at least one non-zero coefficient.

35. The device of claim 34, wherein the video coder is configured to:
code a first inter-view residual prediction flag for the first PU; and
code a second, different inter-view residual prediction flag for the second PU.

36. The device of claim 21, wherein the video coder is configured to:
based on a determination that the current block is coded using skip mode or merge mode, apply motion information of a candidate block, identified by performing the skip mode or the merge mode coding, to the current block;
determine a value for an inter-view residual prediction flag for the candidate block; and
code the current block using inter-view residual prediction when the inter-view residual prediction flag indicates that the candidate block is coded using inter-view residual prediction.

37. The device of claim 21, wherein the video coder is configured to:
determine the value of the coded block flag for the residual reference block indicates that the residual reference block includes at least one non-zero coefficient;
determine a context for coding an inter-view residual prediction flag of the current block using context-adaptive binary arithmetic coding (CABAC) based on a value of an inter-view residual prediction flag of a neighboring block of the current block; and
code the inter-view residual prediction flag of the current block using the determined context.

38. The device of claim 37, wherein the neighboring block comprises at least one of a top neighboring block or a left neighboring block of the current block.

39. The device of claim 38, wherein the video coder is configured to:
when a residual reference block of the neighboring block is available and when the value of the inter-view residual prediction flag of the neighboring block is true, set a context index for the context equal to 1; and
when the residual reference block of the neighboring block is not available, or when the value of the inter-view residual prediction flag of the left neighboring block is false, set the context index equal to 0.

40. The device of claim 21, wherein the video coder is configured to code the current block using inter-view residual prediction without resetting any values of samples of the residual reference block to zero.

41. The device of claim 21, wherein the video coder comprises a video encoder.

42. The device of claim 21, wherein the video coder comprises a video decoder.

43. A video coding device comprising:
means for determining a disparity vector for a current block of video data in a current view based on depth information for the current block, wherein the disparity vector indicates a location of a residual reference block of video data in a reference view relative to the current block;
means for determining a value of a coded block flag for the residual reference block; and
means for coding the current block using inter-view residual prediction only when the value of the coded block flag indicates that the residual reference block includes at least one non-zero coefficient.

44. A computer-readable storage medium having stored thereon instructions that when executed cause one or more processors to:
determine a disparity vector for a current block of video data in a current view based on depth information for the current block, wherein the disparity vector indicates a location of a residual reference block of video data in a reference view relative to the current block;
determine a value of a coded block flag for the residual reference block; and
code the current block using inter-view residual prediction only when the value of the coded block flag indicates that the residual reference block includes at least one non-zero coefficient.
